(19) United States
(12) Patent Application Publication
(10) Pub. No.: US 2026/0064815 A1
(43) Pub. Date: Mar. 5, 2026

(54) SYSTEM AND METHOD FOR MONETIZING TOKENIZED PROPERTY

(71) Applicant: UREEQA INC., Kitchener (CA)

(72) Inventor: Harsch KHANDELWAL, Kitchener (CA)

(21) Appl. No.: 18/717,058

(22) PCT Filed: Dec. 7, 2022
(86) PCT No.: PCT/CA2022/000065

§ 371 Date: Jun. 6, 2024

Related U.S. Application Data
(60) Provisional application No. 63/286,835, filed on Dec. 7, 2021.

(51) Int. Cl. G06F 21/10; G06Q 30/0207; G06Q 40/08; G06Q 50/16

(52) U.S. Cl. CPC G06F 21/1014; G06Q 30/0207; G06Q 40/08; G06Q 50/16

(57) ABSTRACT

A method and system for monetizing tokenized property that enables users to validate their property and then tokenized their validated property. The tokenized property can then be monetized via a monetization process and tracked using blockchain.

### CROSS-REFERENCE TO OTHER APPLICATIONS

The disclosure claims priority from US Provisional Application No. 63/286,807 filed Dec. 7, 2021 which is hereby incorporated by reference.

### TECHNICAL FIELD

The present disclosure relates generally to monetizing property and, more specifically, at a system and method for monetizing tokenized property.

### BACKGROUND

In a digital age, there are more and more varieties of creative works created and copied by individuals or entities without regard to the original creator of the work. Without validation of creative work or intellectual property, buyers and sellers of a creative work are at risk of purchasing or selling a creative work that is not theirs. The same can also hold for non-intellectual or real property.

The protection of copyright in creative works can be complicated, time consuming and difficult. Many national copyright registration agencies do not take any validation steps to attempt to determine whether the work submitted was created by the author, if the work is original, or even if it was previously registered with the copyright registration agency.

Copyright provides the sole legal right, to the copyright owner to reproduce, publish, perform, film, or record the work, and to authorize others to do the same, among many other rights. Generally, an author is the first owner of copyright in any work of the author's authorship. However, first or subsequent ownership may be affected by contract or operation of law. Copyright ownership is enforced through the legal system providing a foundation to enforce any financial or other benefit associated with the copyright.

Therefore, there is provided a novel system and method for monetizing tokenized property.

### SUMMARY

In one aspect of the disclosure, there is provided a method of monetizing tokenized property including minting a validated non-fungible token (NFT) for the property and storing the minted validated NFT to a blockchain; receiving a monetization request for the validated NFT; and performing the monetization process based on the monetization request.

In another aspect, the monetization request is one of a NFT marketplace monetization process; a tradeable NFT rewards program monetization process; an intellectual property collateralization monetization process; a licensing monetization process; a fractional ownership monetization process; or a tokenized insurance monetization process. In another aspect, when the monetization request is the tradeable NFT rewards program monetization process, performing the monetization process based on the monetization request includes receiving indication that new rewards have been added to the validated NFT; updating the validated NFT to include the new rewards; and writing the updated validated NFT to the blockchain. In yet another aspect, when the monetization request is the intellectual property collateralization monetization process, performing the monetization process based on the monetization request includes receiving collateralization information; updating the validated NFT to include the collateralization information; and writing the updated validated NFT to the blockchain. In a further aspect, when the monetization request is the tokenized insurance monetization process, performing the monetization process based on the monetization request includes receiving insurance policy information associated with the validated NFT; updating the validated NFT to include the insurance policy information; and writing the updated validated NFT to the blockchain.

In yet a further aspect, when the monetization request is the tokenized insurance monetization process, performing the monetization process based on the monetization request includes receiving insurance policy information associated with the validated NFT; minting an insurance policy NFT to include the insurance policy information and associating the insurance policy NFT with the validated NFT; and writing the insurance policy NFT to the blockchain. In a further aspect, the disclosure includes determining if a payout of the insurance policy is required; and transmitting payout information to an insurance policy entity. In another aspect, the disclosure further includes deleting the insurance policy NFT is payout is performed.

In an aspect, the monetization request is the fractional ownership monetization process. In another aspect, minting a validated non-fungible token (NFT) for the property and storing the minted validated NFT to a blockchain includes minting the validated NFT with a predetermined number of shares to facilitate fractionalized ownership; and storing the minted validated NFT to the blockchain. In a further aspect, performing the monetization process based on the monetization request includes listing shares available for purchase; receiving indication that at least one of the shares available for purchase has been transacted; and updating validated NFT ownership record based on the share transaction.

In yet another aspect, the monetization request is the licensing monetization process. In another aspect, after minting the validated NFT, minting at least one child NFT associated with the validated NFT; wherein the at least one child NFT provides an owner of the at least one child NFT with rights or licenses to the property associated with the validated NFT. In a further aspect, performing the monetization process based on the monetization request includes listing at least one of the child NFTs for purchase; receiving indication that the at least one child NFT has been transacted; and updating validated NFT ownership record based on the transaction. In another aspect, the disclosure includes performing payment distributions based on the transaction.

### BRIEF DESCRIPTION OF THE DRAWINGS

Embodiments will now be described, by way of example only, with reference to the attached drawings, in which:

FIG. 1 is a schematic diagram of a system for protecting, managing and/or monetizing creative works;

FIG. 2a is a schematic diagram of a system for monetizing tokenized property;

FIG. 2b is a flowchart diagram showing a method of monetizing tokenized property;

FIG. 2c is a schematic diagram of a combined system and method of monetizing tokenized property;

FIG. 2d is another schematic diagram of a combined system and method of monetizing tokenized property;

FIG. 3a is a schematic diagram of a combined system and method for a tokenized tradeable rewards program monetization process;

FIG. 3b is a flowchart diagram showing a method of a tokenized tradeable rewards program monetization process;

FIG. 4a is a schematic diagram of a combined system and method for a tokenized insurance policy monetization process;

FIG. 4b is a flowchart diagram showing a method of a tokenized insurance policy monetization process;

FIG. 5a is a schematic diagram of a combined system and method for an NFT marketplace monetization process;

FIG. 5b is a flowchart diagram showing a method of an NFT marketplace monetization process;

FIG. 6 is a flowchart diagram showing a method of an IP collateralization monetization process;

FIG. 7 is a flowchart diagram showing a method of a fractional ownership monetization process; and

FIG. 8 is a flowchart diagram showing a method of a licensing tokenized property monetization process

### DETAILED DESCRIPTION

The present disclosure provides a system and method for monetizing property such as intellectual property or real property. In one embodiment, the disclosure is directed at a system and method for the monetization of tokenized intellectual property whereby the monetization modules, or components are incorporated into and may be utilized within an intellectual property protection and monetization infrastructure. Examples of property that can be tokenized include, but are not limited to, art, music, digital property, real estate (land/buildings), cigars and the like.

In the following, while a method and system for the monetization of a tokenized copyright is disclosed, it is understood that the method and system may be applied to the monetization of other forms of intellectual property such as, but not limited to, patents, trademarks and industrial designs. The disclosure may also be used for the enforceable and divisible tokenization of non-intellectual or real property such as, but not limited to, cigars, tickets or real estate.

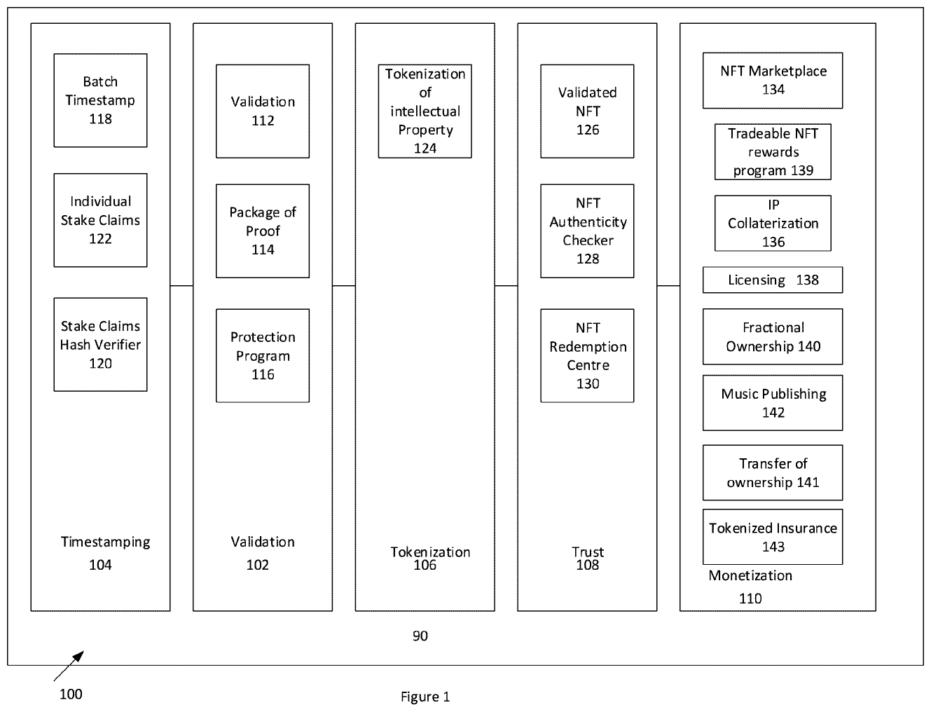

Turning to FIG. 1, a schematic diagram of a system for protecting, managing and/or monetizing creative works is shown. In the following description with respect to the figures, the term creative work will also refer to real property as the described methods and systems may protect both creative works and/or real property.

In one embodiment, the system 100 provides a process and functionality for creators to apply various levels of protection to their creative work, tools to verify the protection of that creative work, processes to provide ongoing monitoring of their creative work, and processes to monetize their creative work using a combination of traditional and blockchain technology. The system 100 may be stored or implemented via a server 90 (such as a web server) that may be in communication with a file server, a database and a blockchain. The system 100 includes at least one processor for executing a program or programs that implement the functionality described herein. In operation, a creator or user interacts with the system from a user computing device, such as, but not limited to, a computer or a smart device.

In the current embodiment, the system 100 includes a decentralized validation of intellectual property (IP), or validation, component 102; a decentralized timestamping of intellectual property, or timestamping, component 104; an enforceable and divisible tokenization of intellectual property, or tokenization, component 106; an encapsulating trust mechanisms into non-fungible tokens (NFTs), or trust, component 108; and a monetization component 110.

With respect to the timestamping component 104, the timestamping component 104 enables creators to post a permanent record (with a timestamp) of their creative work to the blockchain, in a short period of time, such as in minutes. The timestamping component 104 records the claim, or submission, of the creative work as a public, immutable record on a blockchain that the creator can use to prove the creative work is theirs. In one embodiment, the decentralized timestamping of intellectual property component 104 allow claims of ownership to be made quickly and inexpensively by creating, for example, a one-way hash of a submitted creative work on a blockchain (for example, a public blockchain such as Ethereum). This may be seen as a process of decentralized timestamping of intellectual property.

Once a claim of ownership is made, the blockchain will store immutable proof to secure the timestamp of submission. In the current embodiment, the decentralized timestamping of intellectual property component 104 includes a batch timestamp component 118, a stake claim hash verifier component 120 and an individual stake claims component 122. The batch timestamp component 118 and the individual stake claims component 122 may be seen as two modules, executing on the processor that is in communication with a blockchain, that may be able to perform the timestamping of intellectual property on, or to, the blockchain. In one embodiment, the decentralized timestamping of intellectual property component may enable creative works to be created as a record on the blockchain in a batch manner (via batch timestamp component 118) or individually (via individual stakes claim component 122). For the stake claim hash verifier component 120, a hashing function is used to verify the timestamps created from the batch timestamp 118 and/or individual stake claim 122 components. In a particular embodiment, only the hashed file or a zip file (which contains the creative work and other information) provided by the user will be able to generate the stored hash on the blockchain entry. This enables users to prove the claim/timestamp on the blockchain, including the date and time, the name of the user who created the timestamp, and other information. The timestamping component 104 may be seen as the first level of protection that a creator, or user, can use to protect their creative work.

With respect to validation component 102, the validation component 102 may be seen as a next level of protection after the timestamping component 104. The decentralized validation of intellectual property component 102 may include a validation determination component 112, a package of proof component 114 and a protection program component 116 (which may also be seen as a decentralized protection of intellectual property component). The validation determination component 112 may provide the functionality to allow creators of a creative work to increase protection of their creative work by validating the provenance of the creative work. Component 112 provides the functionality to validate the authorship, ownership, and originality, among other things, of an artist's creative work, such as in the form of a validation process. In one embodiment, the validation process may include interaction of the system, executing on the processor, with a team of global validators who work together in a gig-like fashion. In one embodiment, during the validation process, the decentralized network of certified validators may provide input to the system to validate the creative work based on validation criteria, such as, but not limited to, the point in time that the creative work was originated; the authorship and ownership of the creative work; and/or the uniqueness of the creative work. In one embodiment of the validation process, in a gig-like fashion, validators, that may be located globally, will be notified of an electronic creative work submission and the first certified validator(s) to accept the notification get the work. The results generated, or determined, by the validation determination component 112 may then be summarized in a Package of Proof (which may be generated by the package of proof component 114) that documents all steps taken to prove the authenticity of the creative work which may then be stored on the blockchain. The Package of Proof is a permanent, public record stored on the blockchain that the creator can use to prove the work is theirs.

The protection program component 116 may provide the functionality of decentralized protection of intellectual property. In one embodiment, the protection program component interacts with a set of protectors who search the internet and databases for unauthorized and/or unreported use of a creator's creative work and reports any such uses to the creator.

With respect to the protection program component 116, as part of component 102, the system may engage with a network of protectors, where the protectors may be located globally, to scour the digital and physical world for unauthorized and/or unreported use of protected creations. The network of protectors may then interact with the protection program component to assist the system in protecting the creative work from unauthorized use.

In one embodiment of use, the network of protectors may use internal and/or 3^{rd} party technology and databases to identify unreported and/or unauthorized use which is then input to the system via the protection program component 116. In one embodiment, this unauthorized use may be reported and action taken by the system such as, but not limited to, sending out demand letters with links to remedy via payment of a specified amount. In some cases, protectors may be engaged to perform routine monthly checks for unauthorized use. In other cases, the regular monitoring of unauthorized and/or unreported use of IP on platforms like ISPs, using component 116, can be seen as part of a due diligence process that ISPs may employ as part of their response to regulation and lawsuits dealing with copyright infringement on their platforms With respect to the tokenization component 106, once a piece of creative work is validated through the validation component 102, the tokenization component 106 enables the tokenization of the creative work through non-fungible tokens (NFTs). In one embodiment, anyone can mint an NFT, whether they own the creative work or not. The system 100 and tokenization component 106 provides processes to mint NFTs that have been authenticated, or validated, by validation determination component 112, to generate validated NFTs. Only a creative work that has undergone validation, such as via validation determination component 112, will be minted as a validated NFT. Validated NFTs will include a reference to the Package of Proof generated by the package of proof component 114 and other important information to improve trust and transparency in NFTs. In the current embodiment, the tokenization component 106 includes an enforceable tokenization of intellectual property component 124. The tokenization component 106 leverages the strengths of blockchain technology while integrating and respecting the legal contracts required to make the ownership and transfer of NFTs enforceable. In some cases, validated NFTs will include relevant legal documents in the NFTs blockchain record, by way of hashing functions, to enable the transfer of NFTs in a manner that makes the transfer enforceable by the legal system. Tokenization of intellectual property component 124 also enables creators to mint child NFT(s) that are tied to the validated NFT. Child NFTs may also incorporate legal contracts, through hashing functions, to provide rights to the owners of the Child NFTs. In some cases, Child NFTs provide opportunities for monetization of the creative work, such as, for example, licensing, syndication, or the like.

With respect to the encapsulating trust, or trust component 108, the trust component 108 encapsulates trust with respect to the validated, or child, NFT. In one embodiment, the trust component 108 includes a validated NFT component 126, a NFT authenticity checker component 128, and a NFT redemption centre component 130. The encapsulation of trust component may provide trust and transparency to owners, buyers and sellers of NFTs. The encapsulation component 108 may provide the functionality to mint a validated NFT and to then, if desired, mint a collectible NFT associated with the validated NFT. These collectible and validated NFTs may be authenticated by the encapsulation component so that purchasers of these NFTs may have confirmation that they are purchasing an authentic NFT. The NFT authenticity check components 128 and the NFT redemption centre component 130 may be seen as tools that an owner, buyer or seller of NFTs can use to confirm the authenticity of the NFT and confirm information regarding the status of utilities associated with the NFT.

With respect to the monetization component 110, while components 104 (timestamping), 102 (validation), 106 (tokenization), and 108 (encapsulating trust) provide the user with the functionality or processes to protect and tokenize their creative work, the monetization component 110 provides a process for creators to monetize their creative work. In the current embodiment, the monetization component 110 includes a NFT marketplace component 134, an IP Collateralization component 136, a licensing component 138, a fractional ownership component 140, a tokenized tradeable rewards component 139, a transfer of ownership component 141, a tokenized intellectual property insurance component 143 and a music publishing admin (MPA) component 142. The monetization component may provide the functionality for a creator who owns validated creative work, a validated NFT and/or child NFT to monetize their creative work. These monetization processes are enabled by component 110 via its integration with components 104, 102, 106 and 108. The monetization component 110 may provide a plurality of different options for a creator to select and then guides the creator through the process to monetize the creative work in the selected manner. For example, by utilizing results generated by the validation component 102 and tokenization component 106, this may provide important information about the NFT and the associated creative work to an individual or corporation to collateralize the NFT or underwrite insurance on the NFT (using tokenized intellectual property insurance component 143). In another example, utilizing validation component 102, tokenization component 106, and trust component 108, a NFT marketplace (component 134) may provide more trust and transparency to NFT transactions.

The present disclosure provides systems and methods for monetizing tokenized intellectual property (IP) and relates to the monetization component 110 in FIG. 1. Examples of IP include, but are not limited to, patents, trademarks or industrial designs.

The tokenized IP may be represented by a validated NFT that is generated by the validated NFT component. As discussed above, a validated NFT for a creative work is generated after the originality of the creative work has been validated by the system. Once validated, a package of proof is generated and the validated NFT minted based on the package of proof. The validated NFT is then written to the blockchain. In some embodiments, the validated NFT may be minted with a batch of tokens such that the tokens can representation individual ownership shares such that the validated NFT can be co-owned. The validated NFT may also be minted with legal contracts or legal documents that are associated with creative ownership, utilities, purchase terms and the like.

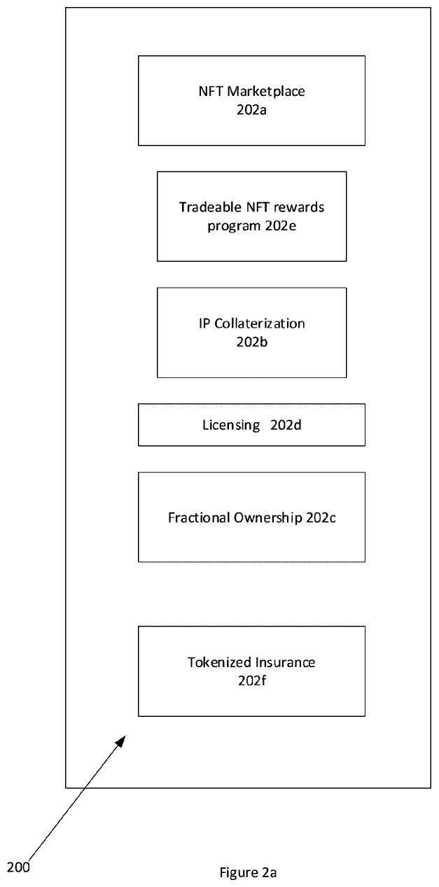

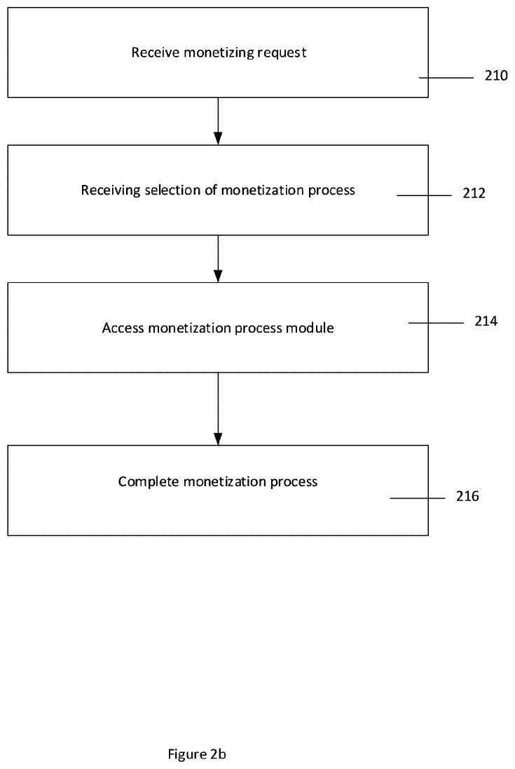

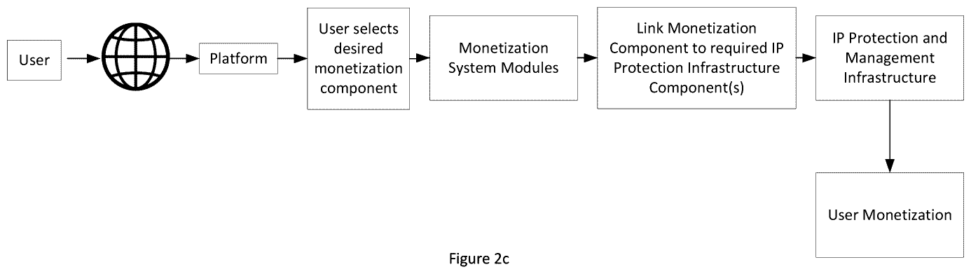

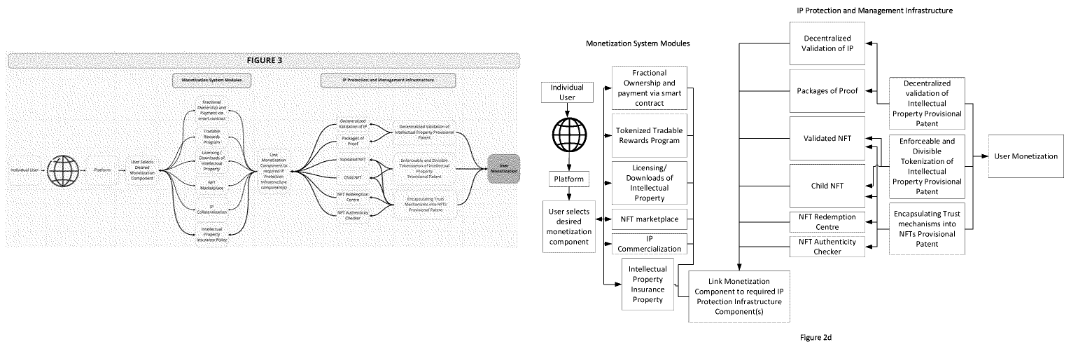

Turning to FIG. 2a, a schematic diagram of one embodiment of a system for monetizing platforms for tokenized property is shown. In the current embodiment, the monetization system 200 includes a set of modules 202 enabling different functionality or options for monetizing tokenized intellectual property. In the current embodiment, the set of modules 202 include a NFT marketplace module or component 202a; an intellectual property collateralization module or component 202b; a fractional ownership of NFTs and payments via smart contracts module or component 202c; a licensing and downloading of intellectual property via smart contracts module or component 202d; a tokenized, tradable rewards programs module or component 202e; and a tokenized intellectual property insurance policies module or component 202f. As will be understood, some modules of the system may also be designed for use with non-intellectual property such as a property collateralization module or component 202b; a licensing and downloading of property via smart contracts module or component 202d; and a tokenized property insurance policies module or component 202f.

The NFT marketplace module or component 202a may be seen as a module that provides the functionality of a marketplace for purchase of tokenized intellectual property or non-intellectual property. In one embodiment, the marketplace module facilitates payments with fiat and/or cryptocurrency (any token type). The module 202a may also validate the source creative work (image, video clip, digital art, etc.) and provide a package of proof to safeguard the buyer while protecting the IP of the creator. In another embodiment, this may also be performed by other components of the system of FIG. 1. The module 202a may also provide the functionality for a user to check the authenticity of NFTs that have been created, stored or displayed by the system, which may also be performed by other components of FIG. 1 (e.g. module 128). The module 202a may also inform the user of any utilities that may convey with the purchase (e.g. signed t-shirt) of the tokenized IP so that resale buyers can more accurately determine their own estimates of current values, which may also be performed by other components of FIG. 1 (e.g. module 128 and/or 130).

The intellectual property collateralization module or component 202b may be seen as a module that provides a functionality where users can borrow stable coins using the tokenized intellectual property as collateral. For example, a visual artist who owns a piece of digital art (or the tokenized IP) can borrow stable coins, using the value of the digital art as collateral. Once the IP relating to the digital art is validated (such as by the system) and represented by or minted to an NFT with a package of proof or proof stored on the blockchain, the NFT can be deposited into a smart contract that allows another user to lend stable coins against it at a predetermined interest rate. If the owner of the IP defaults, the NFT can be sold to recoup the funds lent or transferred by the lender. This module 202b may also allow creators to monetize IP that is not financeable using traditional finance methods or avenues.

The fractional ownership of NFTs and payments via smart contracts module or component 202c may be a module that provides the functionality where owners can sell fractional ownership in their tokenized IP and receive payments via smart contracts. Using validated NFTs, an NFT can be owned by multiple owners via tokens used as share proxies. A smart contract can be used and associated with the NFT so that funds paid into it are distributed to the tokenholders (owners) based on their fractional ownership of the NFT. For example, a musician can sell 5% IP ownership in one of their songs in exchange for a fixed dollar amount. This module may facilitate that transaction and set up a smart contract whereby the original owner and any other owners, or co-owners, receive royalty payments based on their ownership percentages.

The licensing and downloading of intellectual property via smart contracts module or component 202d may be a module which provides the functionality where users can license or, sell for download, their tokenized IP. In one embodiment, whereby the module facilitates the transaction and sets up smart contracts to facilitate payments to parties involved in the transaction. In one embodiment, the module enables a user to e-execute a licensing or purchase agreement related to the validated IP tokenized as an NFT. The digital document representing the agreement can then be hashed using a one way hash function and stored on the blockchain in an NFT that gets issued to the purchaser/licensee. The tokenized IP (in the form of the validated NFT) can then be downloaded or used as per the terms in the agreement.

The tokenized, tradable rewards programs module or component 202e may be a module which provides the functionality for a user to purchase a validated NFT that provides the holder of the NFT with discounts, promotions, and other benefits from participating corporations. Child or collectible NFTs can be minted from a validated NFT of a creative work. This collectible NFT can allow the holder to access special privileges such as, but not limited to, discount codes for e-tailers. The module 202e provides for the functionality of a tokenized rewards program with a collectible wrapper (the creative work). For example, an NFT might have 20 different retailers participating, each of which provide discounts, promotions, and benefits to holders of the NFT.

The tokenized intellectual property insurance policies module or component 202f may be a module which provides the functionality where users can purchase insurance on the tokenized intellectual property, such as acquired through the monetization platform of the current disclosure to protect their purchase. As current NFTs are fraught with buyer risks as the creative work gets used by third parties or possible infringers without permission and tokenized on the blockchain, the purchaser of the insurance may make a claim under the insurance policy if the NFT they acquire is counterfeited. This is similar to a title insurance policy on a home purchase.

As described above, the system of FIG. 1 may provide the decentralized validation of IP whereby the IP (seen as a creative work) can be submitted to the system and validated as being authentic. Validation of the IP may result in the generation of at least one package of proof containing all the evidence collected during the validation process and a copy of the creative work and other information associated with the creative work. Different methods of validation are disclosed in US Provisional Application Nos. 63/139,092 filed Jan. 19, 2021 and 63/250,436 filed Sep. 30, 2021 entitled System and Method for Protecting, Managing and Monetizing Creative Works and US Application No. Ser. No. 17/578,921 entitled System and Method for Protecting, Managing and Monetizing Creative Works Using Blockchain, both of which are hereby incorporated by reference.

Based on the package of proof, at least one validated NFT can be created along with, if desired, a set child NFTs or a set of collectible NFTs associated with the validated NFT. A validated NFT may be seen as a NFT that is minted after the property has been validated by the system. A child NFT is an NFT that is minted and associated with the validated NFT. The system also provides the functionality for a user to authenticate a NFT that is being via the NFT authenticity checker so that a buyer has confidence they are buying an authentic NFT. The system may also include the NFT redemption centre for redeeming utilities associated with a validated NF, child NFT, or collectible NFT. In operation, these components of the system typically interact with the modules 202 of the monetization system 200 to enable the functionality of the monetization system 200. In other embodiments, the modules 202 of the monetization system 200 may be implemented within, tied to or integrated with one or more components of the system of FIG. 1.

In one embodiment of operation, the NFT marketplace module or component 202a interacts with the decentralized validation of Intellectual property; packages of proof; the validated NFTs; the child NFTs; the NFT authenticity checker and/or the NFT redemption centre. In another embodiment of operation, the intellectual property collateralization module or component 202b interacts with the decentralized validation of intellectual property; packages of proof and the validated NFTs. In another embodiment of operation, the fractional ownership of NFTs and payments via smart contracts module or component 202c interacts with the decentralized validation of intellectual property; packages of proof; and the validated NFTs. In another embodiment of operation, the licensing and downloading of intellectual property via smart contracts module or component 202d interacts with the decentralized validation of intellectual property; the packages of proof; the validated NFTs and/or the child NFTs. In yet another embodiment of operation, the tokenized, tradable rewards programs module or component 202e interacts with the decentralized validation of intellectual property and the validated NFTs. In a further embodiment of operation, the tokenized intellectual property insurance policies module or component 202f interacts with the decentralized validation of intellectual property; the packages of proof; the validated NFTs and the child NFTs.

Turning to FIG. 2b, a flowchart outlining a method of monetizing tokenized IP is shown. It is assumed that prior to the execution of this method, a creative work has been submitted by a user and then validated by the system resulting in the generation of a package of proof from which a validated NFT is created. In some embodiment, child and/or collectible NFTs may also be generated based on the validated NFT. Each of these NFTs may then be written to the blockchain.

Initially, a user logs on to or accesses the system which is received by the system in the form of a request for monetizing validated tokenized IP (210) or a request for monetizing a validated NFT that is written on the blockchain. After receiving the request, the system may then receive the type of monetizing process that the user wishes to use (212) for validated NFT that is written on the blockchian. In some embodiments, this information may be transmitted as part of the request for monetizing tokenized IP and in other embodiments; the system may request that this information be inputted by the user such as via a drop down menu box or selection from a list of monetization options (seen as the modules above). After receiving the user selection, the system accesses or executes the selected module (214) for monetizing the validated NFT that is written on the blockchain. The system then completes the monetization process via the selected module (216). In some embodiments, performance of the monetization includes retrieving the validated NFT from the blockchain or for determining authenticity of the validated NFT. Examples of monetization processes are described below.

Turning to FIG. 2c, a schematic diagram of a combined method and system for monetizing tokenized IP is shown. As shown, the user accesses the platform (or system) via a network, such as the Internet. The user then selects the desired monetization which is received by the system for monetizing tokenized IP. The system then links the desired or selected monetization component or module with the tokenized IP (such as in the form of the validated NFT) that is to be monetized. In one embodiment, the user may input the tokenized IP information when accessing the system or the system may require this information from the user once the desired or selected monetization component is received. In other embodiments, the system may link the desired or selected module with the system of FIG. 1 to initiate or execute the desired or selected monetization process. The system then performs the monetization process.

Turning to FIG. 2d, another schematic diagram of the combined method and system for monetizing tokenized IP of FIG. 2c is shown. FIG. 2d provides further detail with examples of monetization system modules and how they connect to the IP protection infrastructure from FIG. 1. As shown in FIG. 2d, examples of these modules include, but are not limited to, a fractional ownership and payment via smart contract module, a tradeable rewards program module, a licensing/downloads of IP module, a NFT marketplace module, an IP collateralization module and an IP insurance property module. Each monetization module may operate in a different manner.

The IP protection management infrastructure (which may also be seen as the system of FIG. 1) provides external functionality to the monetization system modules to perform the monetization. The IP protection management infrastructure provides the functionality of decentralized validation of intellectual property; enforceable and divisible tokenization of intellectual property and encapsulating trust mechanisms into tokenized IP. The IP protection management infrastructure may provide this functionality via the decentralized validation of IP, the packages of proof, the minted validated NFT, child NFTs, the NFT redemption centre and the NFT authenticity checker.

US Provisional Application No. 63/286,835 filed Dec. 7, 2021 teaches systems and methods of enforceable and divisible tokenization of intellectual property and is hereby incorporated by reference. US Provisional Application No. 63/283,354 Filed Nov. 26, 2021 teaches systems and methods of encapsulating trust mechanisms into tokenized IP which is hereby incorporated by reference.

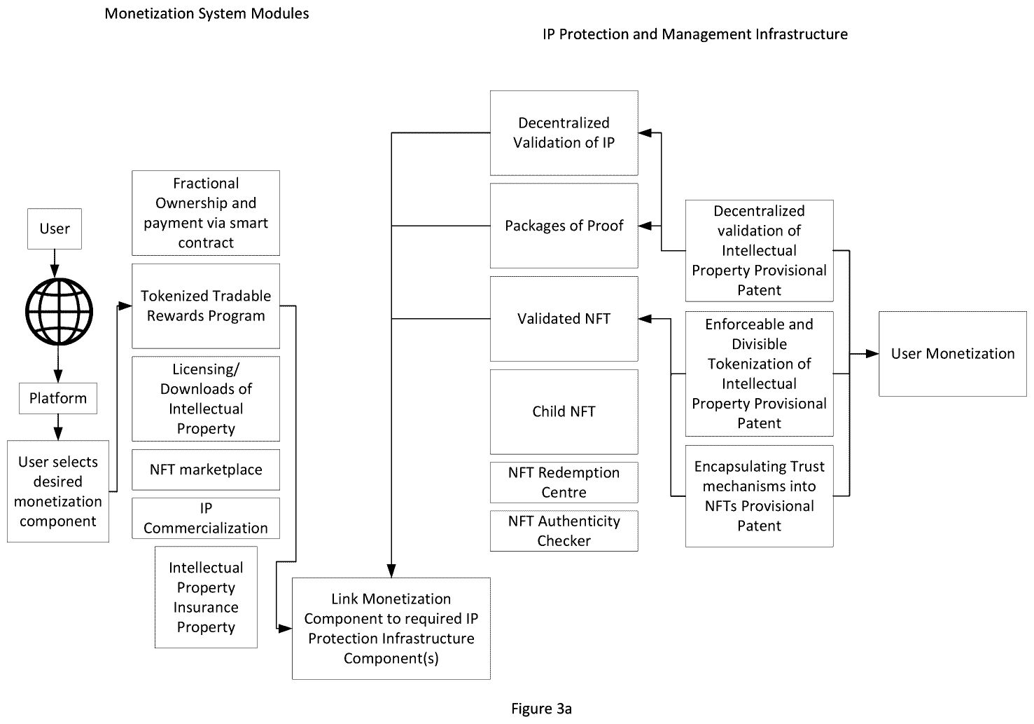

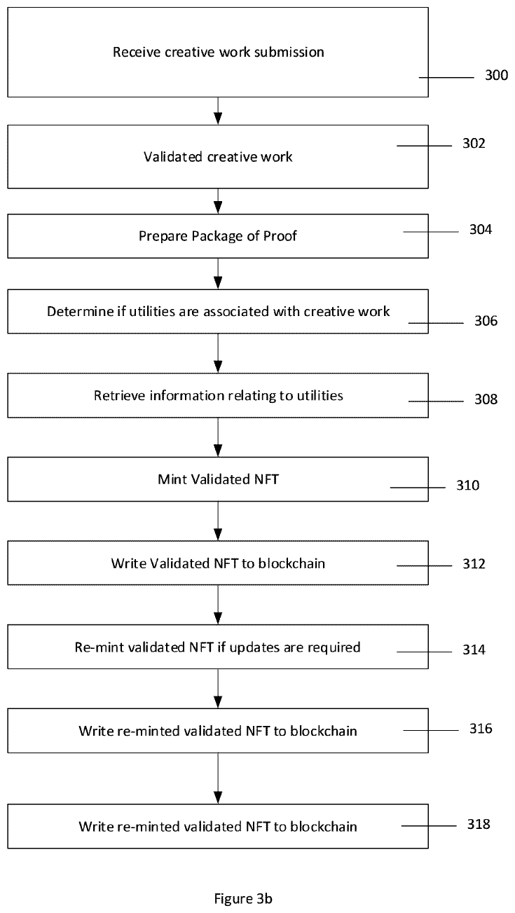

Referring to FIGS. 2a to 2d, if a user selects the tokenized, tradeable rewards process module 202e, the module may interact with the decentralized validation of IP process and validated NFTs. This is schematically shown in FIG. 3a. In this case, the user may be the individual purchasing the validated NFT or a sponsor(s) who wishes to monetize the validated NFT via tokenized, tradable rewards program.

After a creative work has been validated, such as via a decentralized process (as provided by the system of FIG. 1), the creative work is stored as a validated NFT on the blockchain. The validated NFT may then be included as part of a rewards program that is tokenized and tradable and purchasable.

In one embodiment, the validated NFT has two components: (i) a creative work portion like a video or a piece of visual art and (ii) a utility portion that may include one or more associated utilities. The utilities portion may be stored in the form of a legal contract (or a hash of the legal contract) in a manner that can be confirmed. The utilities may be digital or physical such as, but not limited to, access to rewards programs provided by participating sponsors that are associated with the validated NFT (or creative work). In one example, sponsors may include retailers who provide holders of the validated NFT early access to special deals or 20% off merchandise on the retailer's platform. Under this embodiment, each validated NFT may have multiple sponsors and the number of sponsors associated with the validated NFT can grow over time. The holder or buyer of the validated NFT may gain value from: (i) the underlying creative work associated with the validated NFT as it appreciates in value (as with collecting art), and/or, (ii) the value of the one or more utilities associated with the validated NFT that may appreciate over time as the number of sponsors and the value of the rewards associated with the validated NFT grow over time.

As discussed above, during a lifetime of a validated NFT, the validated NFT may be associated with rewards such that the overall value of the validated NFT increases over time. As such, if a buyer happens to purchase a validated NFT, future rewards that are associated with the validated NFT may increase a base value of the validated NFT over the purchase price by the buyer.

Turning to FIG. 3b, a method of providing tokenized, tradeable rewards to a validated NFT is shown. Initially, a creative work submission is received by the system (300). The system then validates the creative work (302) and prepares a package of proof for the creative work if it is approved (304). The system then determines if there are any utilities associated with the creative work (306) and retrieves all information relating to utilities (308). The information may be in the form of legal contracts.

The system then mints a validated NFT (310) with the package of proof and the information (which may be in the form of individual hashes). The validated NFT is then written to the blockchain (312).

If there are any changes to the ownership of the validated NFT or utilities associated with the NFT, the validated NFT is updated by the system to include this information status (314). For example, if a new sponsor provides another utility for the validated NFT, the system may hash the new legal contract and then re-mint the validated NFT to include the new hash. More specifically, over time, sponsors or retailers may be interested in being associated with the validated NFT or may provide utilities or rewards to owners of the NFT. These rewards may increase the overall value of the validated NFT. For instance, if the validated NFT relates to a football player, the player's football team may provide a pair of tickets each year to owners of the validated NFT. Assuming that the pair of tickets have a worth of $500, the value of the validated NFT increases due to this reward.

In another example, the validated NFT may be purchased by an individual where the validation process provides comfort to a buyer that they are entering a valid purchasing agreement. After purchasing the validated NFT, a smart contract associated with the validated NFT is updated to reflect the purchase by the user. The user may purchase the entire right to the validated NFT or may simply purchase a fractional ownership of the validated NFT. The blockchain is the updated with the updated validated NFT (316) and the updated smart contract is then stored in a database (318).

In the ticket example above, all owners of the validated NFT will see the worth of the validated NFT increase whereby if an owner wishes to sell their ownership in the validated NFT, they may be able to sell it for more than their purchase price due to the new pair of tickets reward. This may be seen as how monetizing the NFT via tradeable rewards.

In some embodiments, collectible NFTs can be minted that reference a validated NFT. The agreement providing the details of the sponsors and rewards for the collectible NFT (which may be based on the validated NFT) is hashed and the hash will be included in the collectible NFTs record on the blockchain. The owner of the collectible NFT will have access to the rewards and sponsors detailed in the agreement. The owner and/or prospective buyer of the collectible NFT will be able to connect their wallet containing the collectible NFT or inputting the collectible NFT contract address and ID to check on the rewards and sponsors associated with the NFT.

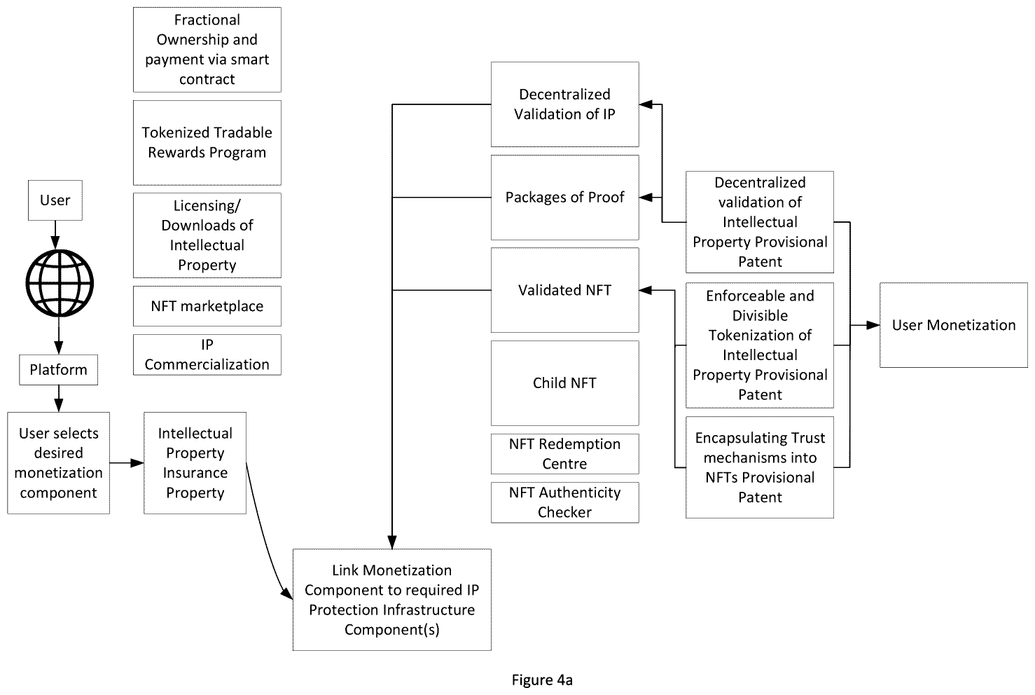

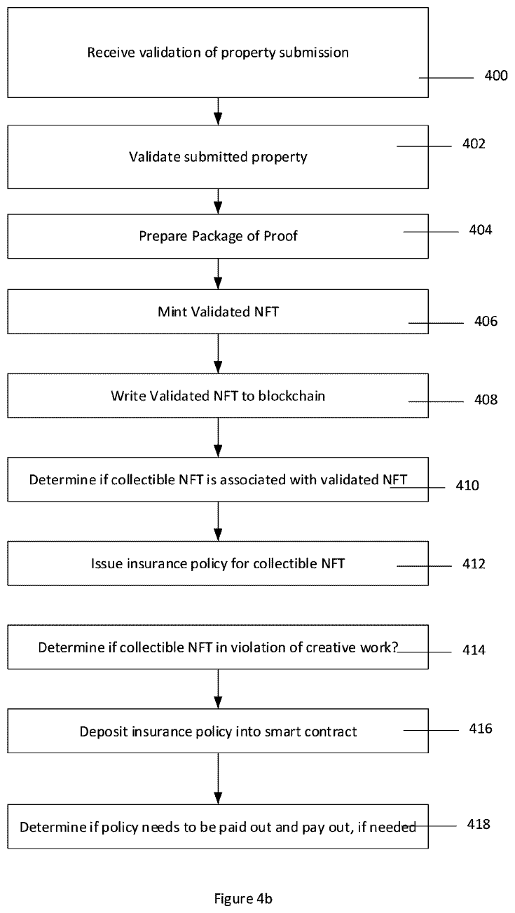

Referring to FIGS. 2a to 2d, if a user selects the tokenized property insurance policies module 202f, the module may interact with the decentralized validation of intellectual property process, packages of proof, a validated NFTs and child NFTs to issue an insurance policy for the validated NFT. This is schematically shown in FIG. 4a. In this case, the user may be purchasing the tokenized intellectual property insurance policy from the insurance provider.

In one embodiment, the module provides a user with access to insurance options to insure the creative work or property (associated with the validated NFT) purchased through the platform. The insurance policy provided will be issued to the buyer of the validated NFT via the method of FIG. 4b. One advantage of providing insurance options includes, but is limited to, the insurance policy gives all parties on the platform added confidence that the validated NFT they are purchasing is authentic. Another advantage is that the insurance policy gives the owner of the validated NFT a basis upon which to make a claim under their NFT insurance policy if the NFT is deemed counterfeited. A further advantage is that the presence of an insurance policy may deter infringers from creating counterfeit NFTs.

Turning to FIG. 4b, a method of providing tokenized intellectual property insurance is shown. Initially, a validation of property submission is received by the system (400). The submission may be a creative work submission which may include the creative work and supporting documents. In other embodiments, the submission may relate to real property, such as, but not limited to, real estate or concert tickets, and supporting documents that may reflect ownership of this real property.

The system then validates the creative work (402) and prepares a package of proof for the creative work if it is validated (404). In some embodiments, the system may then determine if there are any utilities associated with the creative work and retrieves all information relating to utilities. The information may be in the form of legal contracts. The system then mints a validated NFT (406) with the package of proof and any utilities that may be associated with the creative work. The validated NFT is then written to the blockchain (408).

In one embodiment, insurance providers will only provide insurance options for intellectual property that has been validated and minted as validated NFTs in order to provide insurance policies with confidence with respect to originality of the creative work so a check is performed to determine if a collectible NFT is associated with the validated NFT (410). In one embodiment, a master validated NFT can be minted for the source creative work (e.g. image or video clip) and collectible NFTs can be minted that reference the master validated NFT. With collectible NFTs backed by the master validated NFT, an insurance policy can be issued (412) where an insurance NFT can be generated representing an insurance policy on the collectible NFT.

Over time (and unrelated to the method of providing an insurance policy for the validated NFT), the authenticity of a collectible NFT may be questioned and where a determination if the collectible NFT is in violation of the creative work is performed (414). If the collectible NFT is deemed to be in violation of the creator's rights, the insurance policy (or the value of the insurance) associated with the collectible NFT is deposited into a smart contract (416). The system, such as via a decentralized group of validators, or via automated mechanisms can then determine if there is a possible, such as infringement, claim. The system then determines if a payout is required (418). In one example, if there is a payout to be made, the insurance company can be provided with the proof for payout or if on-chain, the insurance NFT can be sent to a smart contract with the payout amount. The insurance NFT can be burned and the smart contract can pay the claim out.

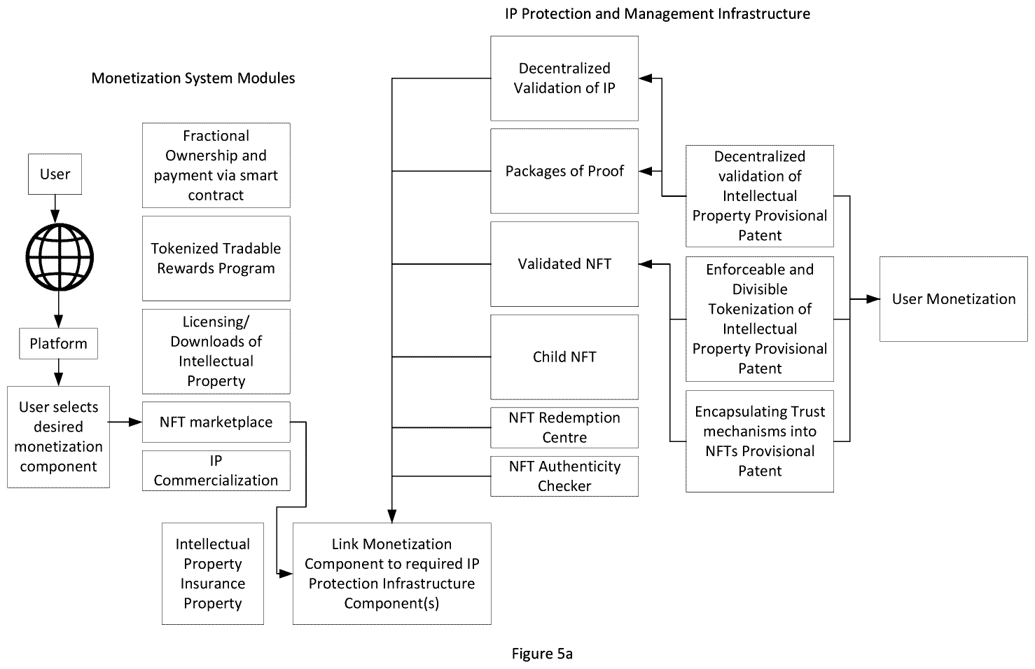

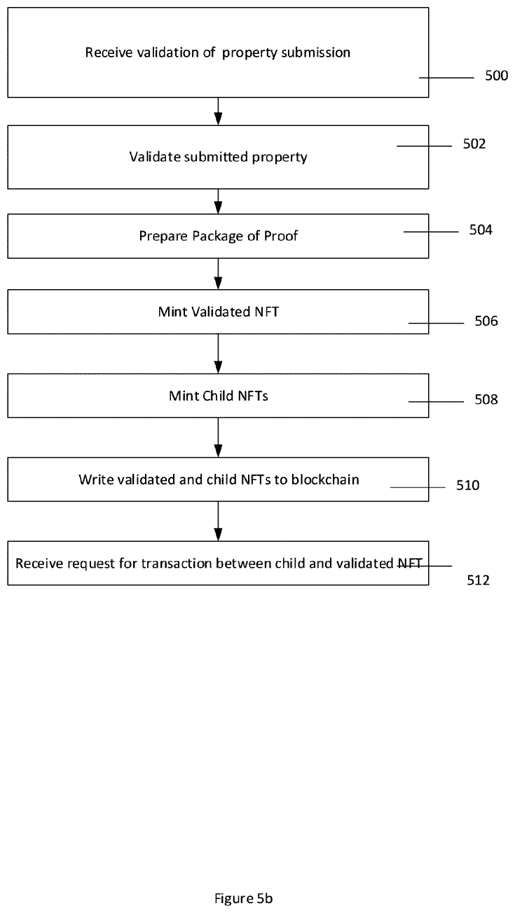

Referring to FIGS. 2a to 2d, if a user selects the NFT marketplace module 202a, the module may interact with the validated NFTs and child NFTs. This is schematically shown in FIGS. 5a and 5b. Turning to FIG. 5b, a method of providing a NFT marketplace is shown.

Initially, a validation of property submission is received by the system (500). The submission may be a creative work submission which may include the creative work and supporting documents. In other embodiments, the submission may relate to real property, such as, but not limited to, real estate or concert tickets, and supporting documents may reflect ownership of this real property.

The system then validates the property (502) and prepares a package of proof for the property if it is validated (504). In some embodiments, the system may then determine if there are any utilities associated with the creative work and retrieves all information relating to utilities. The information may be in the form of legal contracts. The system then mints a validated NFT (506) with the package of proof and any utilities that may be associated with the creative work. The system may then mint a set of Child NFTs associated with the validated NFT (508). The validated NFT and the child NFTs are then written to the blockchain (510).

At some point, the system may then receive a request from a user to enable a transaction between a child and the validated NFT which is facilitated by the NFT marketplace module (512). In some embodiments, the system may enable the licensing and downloading of intellectual property and transferring of intellectual property rights for a child NFT and then facilitate transactions between validated and child NFTs. Other functions may include but not limited to purchase and sale of validated NFTs, in whole or only fractions of the validated NFT; purchase and sale of child NFTs including licensing and downloading of NFTs; minting of validated NFTs and child NFTs; collateralization of intellectual property and borrowing of stable coins against the value of the intellectual property; or purchasing of insurance on intellectual property, as discussed above.

Referring to FIGS. 2a to 2d, if a user selects the IP collateralization module 202b, the module may interact with the decentralized validation of IP process, packages of proof and validated NFTs. The module 202b allows a user to collateralize tokenized IP to facilitate the borrowing of funds against the value of the intellectual property.

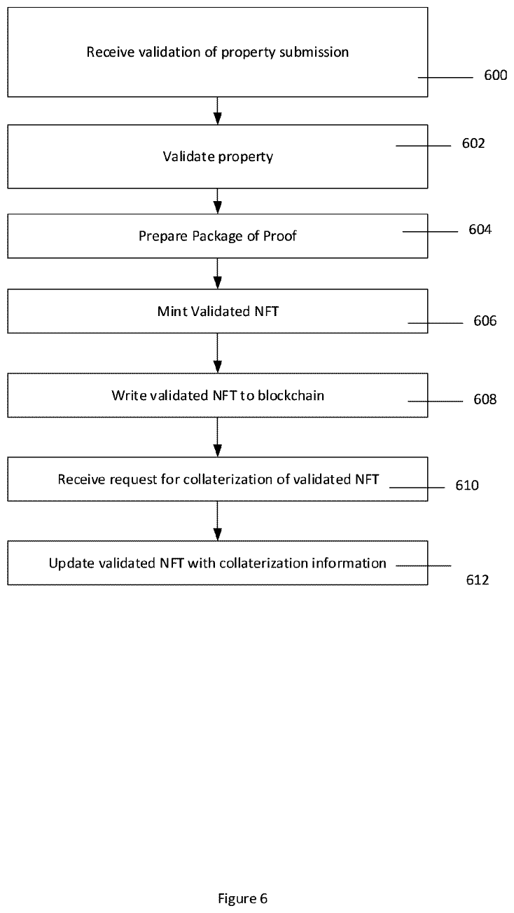

FIG. 6 provides a flowchart outlining a method of IP collateralization. Initially, a validation of property submission is received by the system (600). The system then validates the submitted property (602) and prepares a package of proof for the creative work if it is validated (604). In some embodiments, the system may then determine if there are any utilities associated with the creative work and retrieves all information relating to utilities. The information may be in the form of legal contracts. The system then mints a validated NFT (606) with the package of proof and any utilities that may be associated with the creative work. The validated NFT is then written to the blockchain (608).

Over time, the validated NFT may be selected for collateralization (610). The system may then update the validated NFT to include information associated with the collateralization agreement (612). In one embodiment, a hash of the collateralization agreement may be stored to the validated NFT and the updated validated NFT written to the blockchain. In another embodiment, the system may determine or may receive via an input or valuation of the validated NFT and then any collateralization agreement that has been generated for the validated NFT which are all then stored in the updated validated NFT and the updated validated NFT written to the blockchain.

Referring to FIGS. 2a to 2d, if a user selects the fractional ownership of NFTs and payments via smart contracts module or component 202c, the module may interact with the decentralized validation of IP process, packages of proof and validated NFTs. The module 202c allows for fractional ownership of a validated NFT.

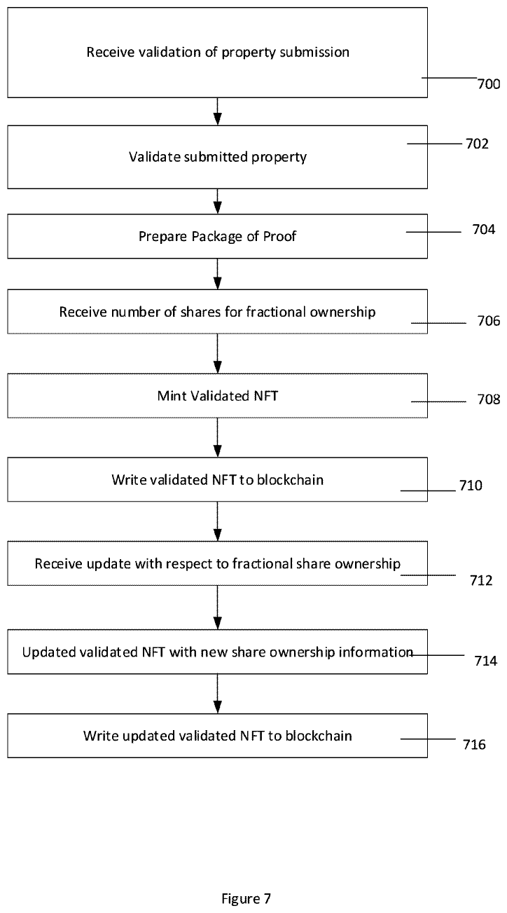

FIG. 7 provides a flowchart outlining a method of IP collateralization. Initially, a validation of property submission is received by the system (700). The system then validates the submitted property (702) and prepares a package of proof for the creative work if it is validated (704). In some embodiments, the system may then determine if there are any utilities associated with the creative work and retrieves all information relating to utilities. The information may be in the form of legal contracts. The system may then determine or receive a number of shares that are being issued for the property (706). The system then mints a validated NFT (708) with a set of tokens (which in one embodiment is equal to the number of shares) along with the package of proof and any utilities that may be associated with the creative work. The validated NFT is then written to the blockchain (710).

The fractional ownership shares may then be listed for sale for individuals to buy. When a new buyer of a share of the validated NFT comes forward, an indication of and information relating to the purchase is received by the system (712). In some embodiments, the system may handle the sales transaction as well. The system then updates the validated NFT with the new owner information or new fractional ownership share (714). In some embodiments, the updated validated NFT is then written to the blockchain (716) although in other embodiments, the information stored in the updated validated NFT is simply saved in a smart contract associated with the validated NFT and there is no need to write the updated validated NFT to the blockchain.

Referring to FIGS. 2a to 2d, if a user selects the a licensing and downloading of intellectual property via smart contracts module or component 202d; the module may interact with the decentralized validation of IP process, packages of proof and validated and child NFTs. The module 202d allows for the monetization of tokenized IP by enabling the tokenized IP (or tokenized property) to be licensed.

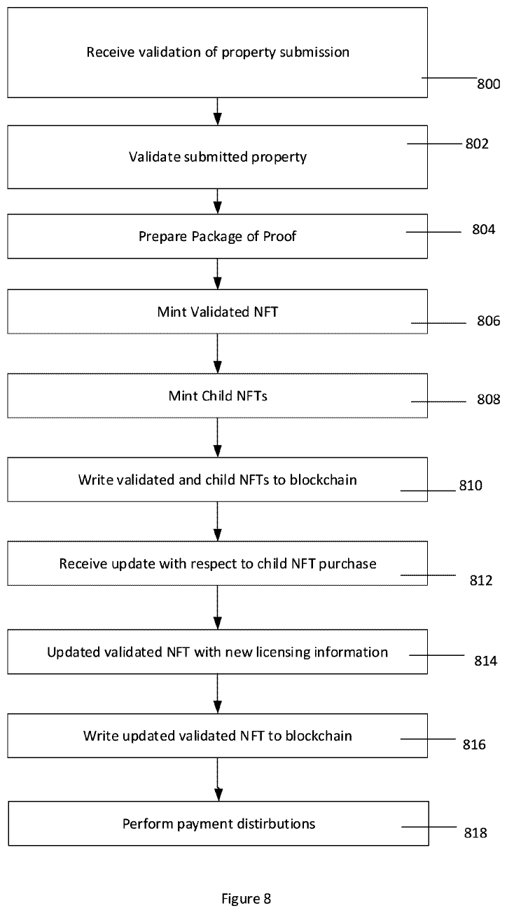

FIG. 8 provides a flowchart outlining a method of IP collateralization. Initially, a validation of property submission is received by the system (800). The system then validates the submitted property (802) and prepares a package of proof for the creative work if it is validated (804). In some embodiments, the system may then determine if there are any utilities associated with the creative work and retrieves all information relating to utilities. The information may be in the form of legal contracts. The system then mints a validated NFT (806) along with the package of proof and any utilities that may be associated with the creative work or property and then mints child NFTs (808) that are associated with the validated NFT. In the current embodiment, these child NFTs may be specifically minted for licensing. The validated and child NFTs are then written to the blockchain (810). The child NFTs assist in providing a mechanism for the validated NFT to be licensed for an individual who purchases a child NFT set out for licensing.

The child NFTs that is/are available for licensing may then be listed for sale for individuals to buy. When there is a purchase of a child NFT, an indication of and information relating to the purchase is received by the system (812). The system then updates the validated NFT with the new licensing information (814). In some embodiments, the updated validated NFT is then written to the blockchain (816) although in other embodiments, the information stored in the updated validated NFT is simply saved in a smart contract associated with the validated NFT and there is no need to write the updated validated NFT to the blockchain. The system then performs the required payment distributions based on the licensing agreement (818).

In the preceding description, various monetization system modules are presented, however, these modules are only some possible examples. There may be other monetization modules or functionality that may also leverage the system of FIG. 1. The system and method of the disclosure is modular and all, or individual, components, may apply to various applications. For example, an existing NFT marketplace may employ only validated NFTs and NFT authenticity checker. In another example, an existing NFT marketplace may employ validated NFTs, insurance of validated NFTs and intellectual property collateralization of validated NFTs. In another example, a new NFT marketplace may employ all of the monetization modules and FIG. 1 components.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only.

Alterations, modifications and variations can be effected to the particular embodiments by those of skill in the art without departing from the scope, which is defined solely by the claim appended hereto.

What is claimed is:

1. A method of monetizing tokenized property comprising:
minting a validated non-fungible token (NFT) for the property and storing the minted validated NFT to a blockchain;
receiving a monetization request for the validated NFT; and
performing the monetization process based on the monetization request.

2. The method of claim 1 wherein the monetization request is one of a NFT marketplace monetization process; a tradeable NFT rewards program monetization process; an intellectual property collateralization monetization process; a licensing monetization process; a fractional ownership monetization process; or a tokenized insurance monetization process.

3. The method of claim 2 wherein when the monetization request is the tradeable NFT rewards program monetization process and performing the monetization process based on the monetization request comprises:
receiving indication that new rewards have been added to the validated NFT;
updating the validated NFT to include the new rewards; and
writing the updated validated NFT to the blockchain.

4. The method of claim 2 wherein the monetization request is the intellectual property collateralization monetization process and performing the monetization process based on the monetization request comprises:
receiving collateralization information;
updating the validated NFT to include the collateralization information; and
writing the updated validated NFT to the blockchain.

5. The method of claim 2 wherein the monetization request is the tokenized insurance monetization process and performing the monetization process based on the monetization request comprises:
receiving insurance policy information associated with the validated NFT;
updating the validated NFT to include the insurance policy information; and
writing the updated validated NFT to the blockchain.

6. The method of claim 2 wherein the monetization request is the tokenized insurance monetization process and performing the monetization process based on the monetization request comprises:
receiving insurance policy information associated with the validated NFT;
minting an insurance policy NFT to include the insurance policy information and associating the insurance policy NFT with the validated NFT; and
writing the insurance policy NFT to the blockchain.

7. The method of claim 6 further comprising:
determining if a payout of the insurance policy is required; and
transmitting payout information to an insurance policy entity.

8. The method of claim 7 further comprising deleting the insurance policy NFT is payout is performed.

9. The method of claim 2 wherein the monetization request is the fractional ownership monetization process.

10. The method of claim 9 wherein minting a validated non-fungible token (NFT) for the property and storing the minted validated NFT to a blockchain comprises:
minting the validated NFT with a predetermined number of shares to facilitate fractionalized ownership; and
storing the minted validated NFT to the blockchain.

11. The method of claim 10 wherein performing the monetization process based on the monetization request comprises:
listing shares available for purchase;
receiving indication that at least one of the shares available for purchase has been transacted; and
updating validated NFT ownership record based on the share transaction.

12. The method of claim 2 wherein the monetization request is the licensing monetization process.

13. The method of claim 12 further comprising, after minting the validated NFT:
minting at least one child NFT associated with the validated NFT;
wherein the at least one child NFT provides an owner of the at least one child NFT with rights or licenses to the property associated with the validated NFT.

14. The method of claim 13 wherein performing the monetization process based on the monetization request comprises:
listing at least one of the child NFTs for purchase;
receiving indication that the at least one child NFT has been transacted; and
updating validated NFT ownership record based on the transaction.

15. The method of claim 14 further comprising:
performing payment distributions based on the transaction.
